(19) United States
(12) Patent Application Publication
(10) Pub. No.: US 2003/0009505 A1
(43) Pub. Date: Jan. 9, 2003

(54) Method, system, and product for processing HTTP requests based on request type priority

(75) Inventors: Gennaro A. Cuomo, Apex, NC (US); Matt Richard Hogstrom, Apex, NC (US)

Correspondence Address: A. Bruce Clay, IBM Corporation T81/503, PO Box 12195, Research Triangle Park, NC, 27709, US

(73) Assignee: International Business Machines Corporation, Armonk, NY (US)

(21) Appl. No.: 09/898,366

(22) Filed: Jul. 3, 2001

(51) Int. Cl. G06F 9/00; G06F 15/16

(52) U.S. Cl. 709/103; 709/203

(57) ABSTRACT

A method, system, and product are disclosed for reordering the processing of HTTP requests. A computer system is included which is executing a Web-based application. A priority is associated with each one of different types of HTTP requests. Multiple HTTP requests are then received by the Web-based application. A priority associated with a type of each of the HTTP requests is determined. The HTTP requests that are associated with a higher priority are processed before processing the HTTP requests that are associated with a lower priority.

### FIELD OF THE INVENTION

The present invention relates to a computer system, and more particularly to a computer system, method, and product for reordering HTTP requests and processing high priority requests first.

### BACKGROUND OF THE INVENTION

The Internet includes the World Wide Web. Web-based applications, executed by server computer systems, may be accessed by client computer systems. In order to access a Web-based application, a user first must establish an Internet connection with the user's client computer system. The user then specifies a particular URL (uniform resource locator). The URL includes a first portion, such as “http”, which identifies a particular protocol. The next portion typically specifies a particular server, such as “www.ibm.com” which identifies a particular IBM server. The next portion, also called a URI (uniform resource identifier), identifies a particular page, document, or object within the specified server. The server computer system executes the Web-based application which then responds to the URL requests. A request is defined as an HTTP protocol flow sent from a client to a server for processing.

A user may make one of a variety of different types of HTTP requests. For example, a user may browse a page in a catalog by submitting a URL which specifies the particular catalog page. The user may make a purchase by submitting a URL which specifies the completion of an order.

In known systems, all requests are processed using a first come, first served approach. Each request is processed by the server in the order in which the requests were received. This approach may be satisfactory where the server is capable of processing each request immediately when it is received. This, however, is not typically possible. The server usually buffers received requests and processes them in order of receipt. Therefore, if a server has four pending requests to browse a catalog page that were received before ten pending purchase requests, the browsing requests will be processed first.

Therefore, a need exists for a method, system, and product which reorders the processing of HTTP requests according to a priority assigned to each type of request which may be received, and processing high priority requests first.

### SUMMARY OF THE INVENTION

A method, system, and product are disclosed for reordering the processing of HTTP requests. A computer system is included which is executing a Web-based application. A priority is associated with each one of different types of HTTP requests. Multiple HTTP requests are then received by the Web-based application. A priority associated with a type of each of the HTTP requests is determined. The HTTP requests that are associated with a higher priority are processed before processing the HTTP requests that are associated with a lower priority.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with the present invention;

FIG. 3 is a block diagram illustrating a data processing system that may be implemented as a client in accordance with the present invention;

FIG. 4 is a high level flow chart which depicts establishing a plurality of queues for storing prioritized requests in accordance with the present invention;

FIG. 5 is a high level flow chart which illustrates receiving and storing requests in queues according to the requests' priority in accordance with the present invention; and

FIG. 6 is a high level flow chart which depicts processing higher priority requests prior to processing lower priority requests in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The invention is preferably realized using a well-known computing platform, such as an IBM RS/6000 server running the IBM AIX operating system. However, it may be realized in any computer system platforms, such as an IBM personal computer running the Microsoft Windows operating system or a Sun Microsystems workstation running operating systems such as UNIX or LINUX or a router system from Cisco or Juniper, without departing from the spirit and scope of the invention.

The present invention is a method, system, and product for reordering the processing of HTTP requests. A server computer system is included which is executing a Web-based application. A plurality of different priorities are first specified. A priority is associated with each one of different types of HTTP requests. A plurality of different queues are also established. Each queue is associated with a different one of the priorities.

If there exists no backlog of pending requests to be executed, requests are executed as they are received. If a backlog does exist, the application first determines the type of each new request as the request is received. The priority associated with this type is determined. The queue which is associated with this priority is then identified. The new request is then stored in the identified queue.

The application executes requests stored in the higher priority queues before processing requests stored in the lower priority queues. In this manner, high priority type requests are processed before low priority type requests.

The type of request may be identified using one of several different methods. For example, the URI of a request, the user ID, the particular Web application, or any other combination of information found in the incoming request header, which includes the IP address, device type, and other information, may be used. The type of request may also be determined from the incoming network header, which includes the TCP header.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

Clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network.

In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

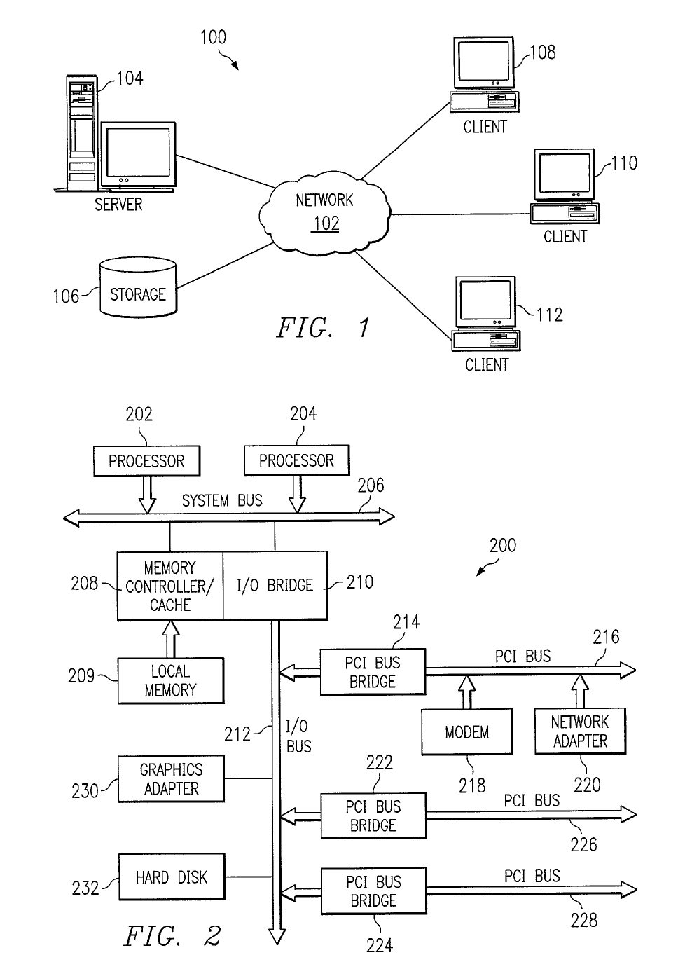

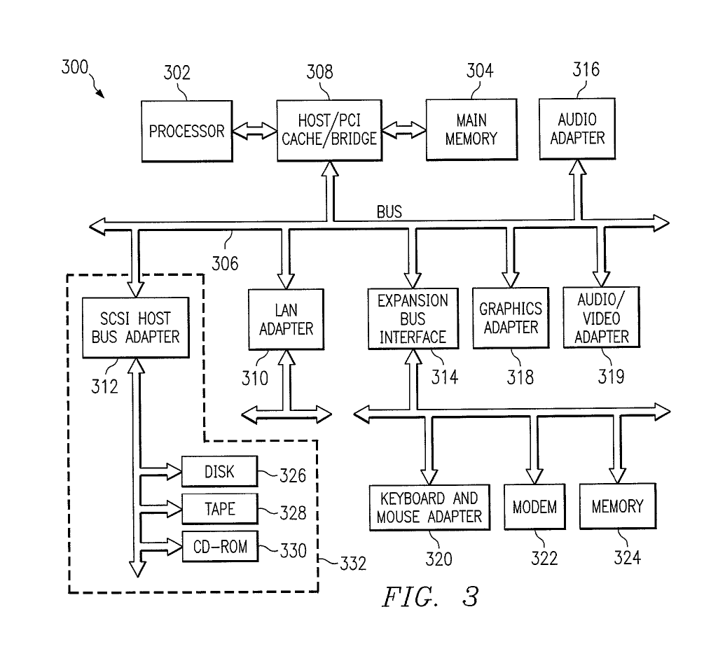

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

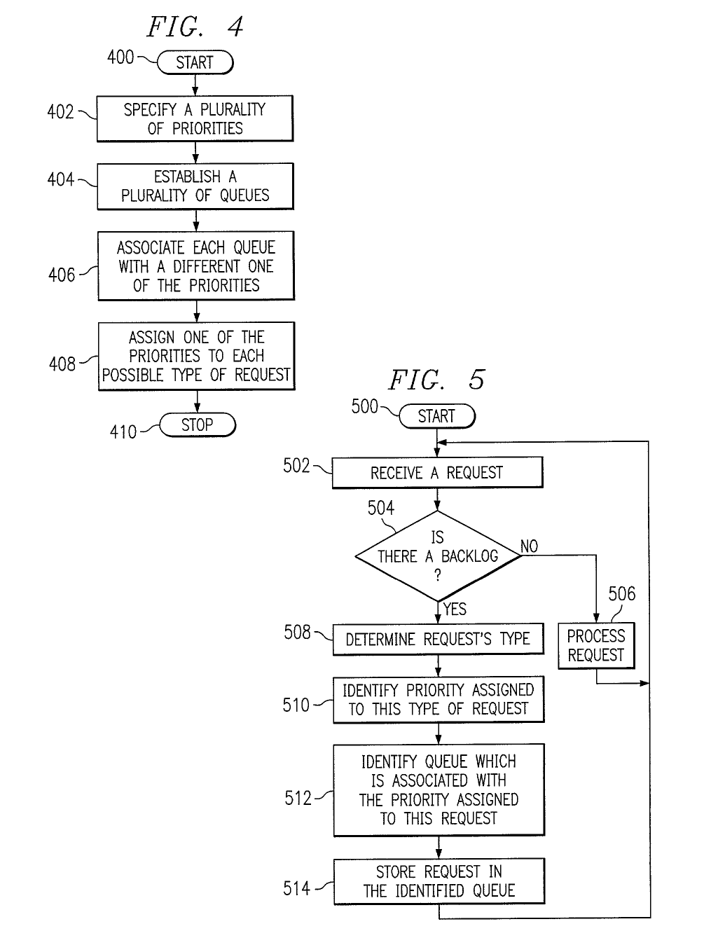

FIG. 4 is a high level flow chart which depicts establishing a plurality of queues for storing prioritized requests in accordance with the present invention. The process starts as depicted by block 400 and thereafter passes to block 402 which illustrates a specification of a plurality of priorities. For example, in one embodiment, three or more priorities may be specified. In another embodiment, only two priorities may be specified. Next, block 404 depicts the establishment of a plurality of queues. Thereafter, block 406 illustrates associating each queue with a different one of the priorities. Block 408, then, depicts assigning one of the priorities to each possible type of request. For example, there may be requests to make a purchase, requests to search for a particular product, requests to obtain information, and other types of requests. The process then terminates as illustrated by block 410.

FIG. 5 is a high level flow chart which illustrates receiving and storing requests in queues according to the requests' priority in accordance with the present invention. The process starts as depicted by block 500 and thereafter passes to block 502 which illustrates a server computer system, which is executing a Web-based application, receiving a request. Next, block 504 depicts a determination of whether or not there exists a backlog of requests. If a determination is made that there is no backlog of requests, the process passes to block 506 which illustrates immediately processing the received request. The process then passes back to block 502.

Referring again to block 504, if a determination is made that there is a backlog, the process passes to block 508 which depicts a determination of the request's type. Next, block 510 illustrates identifying the priority that is assigned to this type of request. Thereafter, block 512 depicts identifying the queue that is associated with the priority assigned to this request. Block 514, then, illustrates storing the request in the queue identified as depicted by block 512. The process then passes back to block 502.

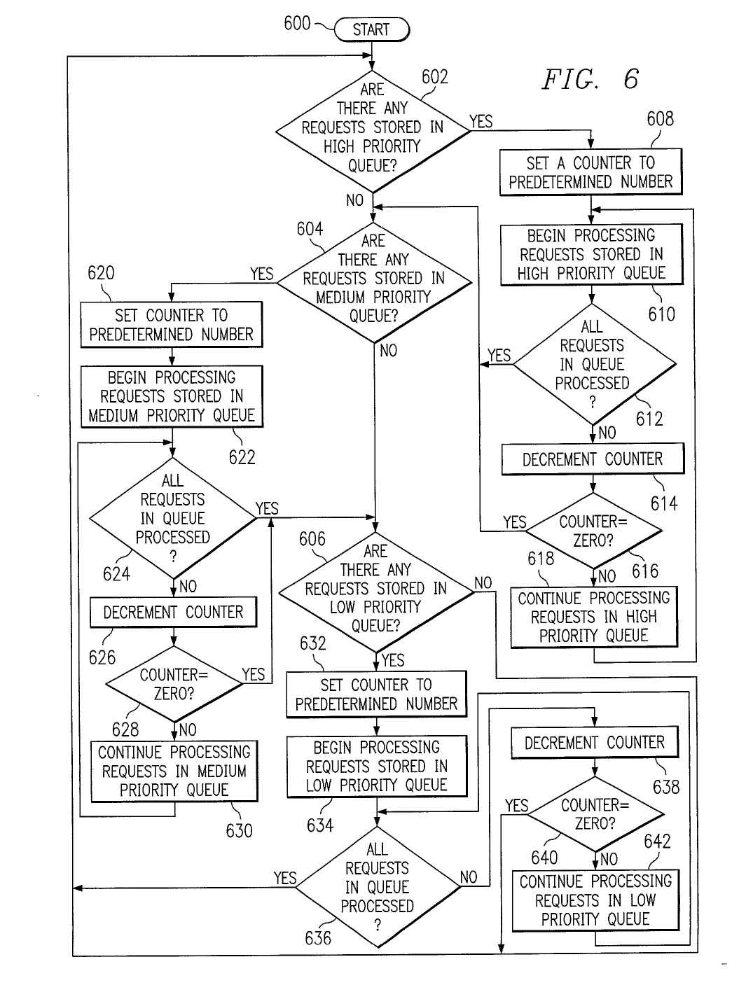

FIG. 6 is a high level flow chart which depicts processing higher priority requests prior to processing lower priority requests in accordance with the present invention. The process starts as illustrated by block 600 and thereafter passes to block 602 which depicts a determination of whether or not there are any pending requests stored in the high priority queue. If a determination is made that there are no requests currently stored in the high priority queue, the process passes to block 604 which illustrates a determination of whether or not there are any pending requests stored in the medium priority queue. If a determination is made that there are no requests currently stored in the medium priority queue, the process passes to block 606 which depicts a determination of whether or not there are any pending requests stored in the low priority queue. If a determination is made that there are no requests currently stored in the low priority queue, the process passes back to block 602.

Referring again to block 602, if a determination is made that there are requests currently stored in the high priority queue, the process passes to block 606 which illustrates setting a counter to a predetermined number. The number will be the maximum number of requests to be executed before checking any other queues. The process then passes to block 610 which depicts beginning processing of the requests stored in the high priority queue. Thereafter, block 612 illustrates a determination of whether or not all of the requests which had been stored in the high priority queue have all now been processed. If a determination is made that all requests in the high priority queue have been processed, the process passes to block 604.

Referring again to block 612, if a determination is made that there are additional requests in the high priority queue that need to be processed, the process passes to block 614 which illustrates decrementing the counter. Next, block 616 depicts a determination of whether or not the counter is now equal to zero. If a determination is made that the counter is not equal to zero, the process passes to block 618 which illustrates a continuation of processing requests in the high priority queue. The process passes back to block 610. Referring again to block 616, if a determination is made that the counter is now equal to zero, the process passes to block 604.

Referring again to block 604, if a determination is made that there are requests currently stored in the medium priority queue, the process passes to block 620 which illustrates setting a counter to a predetermined number. The process then passes to block 622 which depicts beginning processing of the requests stored in the medium priority queue. Thereafter, block 624 illustrates a determination of whether or not all of the requests which had been stored in the medium priority queue have all now been processed. If a determination is made that all requests in the medium priority queue have been processed, the process passes to block 606.

Referring again to block 624, if a determination is made that there are additional requests in the medium priority queue that need to be processed, the process passes to block 626 which illustrates decrementing the counter. Next, block 628 depicts a determination of whether or not the counter is now equal to zero. If a determination is made that the counter is not equal to zero, the process passes to block 630 which illustrates continuing the processing of the requests stored in the medium priority queue. The process then passes back to block 624. Referring again to block 628, if a determination is made that the counter is now equal to zero, the process passes to block 606.

Referring again to block 606, if a determination is made that there are requests currently stored in the low priority queue, the process passes to block 632 which illustrates setting a counter to a predetermined number. The process then passes to block 634 which depicts beginning processing of the requests stored in the low priority queue. Thereafter, block 636 illustrates a determination of whether or not all of the requests which had been stored in the low priority queue have all now been processed. If a determination is made that all requests in the low priority queue have been processed, the process passes to block 602.

Referring again to block 636, if a determination is made that there are additional requests in the low priority queue that need to be processed, the process passes to block 638 which illustrates decrementing the counter. Next, block 640 depicts a determination of whether or not the counter is now equal to zero. If a determination is made that the counter is not equal to zero, the process passes to block 642 which illustrates continuing the processing of the requests stored in the low priority queue. The process then passes back to block 636. Referring again to block 640, if a determination is made that the counter is now equal to zero, the process passes to block 602.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a computer system executing a Web-based application, said method comprising the steps of:
associating a priority with each one of a plurality of different types of HTTP requests that are processed by said application; and
processing ones of a plurality of HTTP requests that are associated with a higher priority before processing ones of said plurality of HTTP requests that are associated with a lower priority.

2. The method according to claim 1, further comprising the steps of:
establishing a plurality of different priorities; and
determining one of said plurality of different priorities associated with said type of each of said plurality of HTTP requests.

3. The method according to claim 2, further comprising the steps of:
establishing a plurality of different queues; and
associating each one of said plurality of different queues with a different one of said plurality of priorities.

4. The method according to claim 3, further comprising the steps of:
storing said plurality of HTTP requests in said plurality of queues;
ones of said plurality of HTTP requests that are associated with a first one of said plurality of priorities being stored in a first one of said plurality of queues, wherein said first one of said plurality of queues being associated with said first one of said plurality of priorities; and
ones of said plurality of HTTP requests that are associated with a second one of said plurality of priorities being stored in a second one of said plurality of queues, wherein said second one of said plurality of queues being associated with said second one of said plurality of priorities.

5. The method according to claim 1, further comprising the steps of:
receiving said plurality of HTTP requests by said application; and
determining a priority associated with a type of each one of said plurality of HTTP requests.

6. The method according to claim 1, further comprising the steps of:
receiving one of said plurality of HTTP requests by said application;
determining whether there is a backlog of pending requests waiting to be processed by said application;
in response to a determination that there is no backlog, immediately processing said one of said plurality of HTTP requests;
in response to a determination that there is a backlog, determining a type of said one of said plurality of requests;
identifying a priority associated with said type;
identifying one of a plurality of queues that is associated with said priority; and
storing said one of said plurality of requests in said identified one of said plurality of queues.

7. The method according to claim 1, further comprising the steps of:
establishing a plurality of different queues;
associating each one of said plurality of different queues with a different one of a plurality of priorities; and
processing requests stored in one of said plurality of queues that is associated with a first priority before processing requests stored in one of said plurality of queues that is associated with a second priority.

8. The method according to claim 7, further comprising the steps of:
storing ones of said plurality of requests having a type associated with a high priority in one of said plurality of queues that is associated with said high priority;
storing ones of said plurality of requests having a type associated with a low priority in one of said plurality of queues that is associated with said low priority; and
processing said ones of said plurality of requests stored in said one of said plurality of queues that is associated with said high priority before processing said ones of said plurality of requests stored in said one of said plurality of queues that is associated with a low priority.

9. A computer program product in a computer system executing a Web-based application, comprising:
instruction means for associating a priority with each one of a plurality of different types of HTTP requests that are processed by said application; and
instruction means for processing ones of a plurality of HTTP requests that are associated with a higher priority before processing ones of said plurality of HTTP requests that are associated with a lower priority.

10. The product according to claim 9, further comprising:
instruction means for establishing a plurality of different priorities; and
instruction means for determining one of said plurality of different priorities associated with said type of each of said plurality of HTTP requests.

11. The product according to claim 10, further comprising:
instruction means for establishing a plurality of different queues; and
instruction means for associating each one of said plurality of different queues with a different one of said plurality of priorities.

12. The product according to claim 11, further comprising:
instruction means for storing said plurality of HTTP requests in said plurality of queues;
instruction means for ones of said plurality of HTTP requests that are associated with a first one of said plurality of priorities being stored in a first one of said plurality of queues, wherein said first one of said plurality of queues being associated with said first one of said plurality of priorities; and
instruction means for ones of said plurality of HTTP requests that are associated with a second one of said plurality of priorities being stored in a second one of said plurality of queues, wherein said second one of said plurality of queues being associated with said second one of said plurality of priorities.

13. The product according to claim 9, further comprising:
instruction means for receiving said plurality of HTTP requests by said application; and
instruction means for determining a priority associated with a type of each one of said plurality of HTTP requests.

14. The product according to claim 9, further comprising:
instruction means for receiving one of said plurality of HTTP requests by said application;
instruction means for determining whether there is a backlog of pending requests waiting to be processed by said application;
instruction means responsive to a determination that there is no backlog, for immediately processing said one of said plurality of HTTP requests;
instruction means responsive to a determination that there is a backlog, for determining a type of said one of said plurality of requests;
instruction means for identifying a priority associated with said type;
instruction means for identifying one of a plurality of queues that is associated with said priority; and
instruction means for storing said one of said plurality of requests in said identified one of said plurality of queues.

15. The product according to claim 9, further comprising:
instruction means for establishing a plurality of different queues;
instruction means for associating each one of said plurality of different queues with a different one of a plurality of priorities; and
instruction means for processing requests stored in one of said plurality of queues that is associated with a first priority before processing requests stored in one of said plurality of queues that is associated with a second priority.

16. The product according to claim 15, further comprising:
instruction means for storing ones of said plurality of requests having a type associated with a high priority in one of said plurality of queues that is associated with said high priority;
instruction means for storing ones of said plurality of requests having a type associated with a low priority in one of said plurality of queues that is associated with said low priority; and
instruction means for processing said ones of said plurality of requests stored in said one of said plurality of queues that is associated with said high priority before processing said ones of said plurality of requests stored in said one of said plurality of queues that is associated with a low priority.

17. A computer system executing a Web-based application, comprising:
a priority being associated with each one of a plurality of different types of HTTP requests that are processed by said application; and
said system including a CPU executing code for processing ones of a plurality of HTTP requests that are associated with a higher priority before processing ones of said plurality of HTTP requests that are associated with a lower priority.

18. The system according to claim 17, further comprising:
a plurality of different priorities; and
said CPU executing code for determining one of said plurality of different priorities associated with said type of each of said plurality of HTTP requests.

19. The system according to claim 18, further comprising:
a plurality of different queues; and
said CPU executing code for associating each one of said plurality of different queues with a different one of said plurality of priorities.

20. The system according to claim 19, further comprising:
said plurality of HTTP requests being stored in said plurality of queues;
ones of said plurality of HTTP requests that are associated with a first one of said plurality of priorities being stored in a first one of said plurality of queues, wherein said first one of said plurality of queues being associated with said first one of said plurality of priorities; and
ones of said plurality of HTTP requests that are associated with a second one of said plurality of priorities being stored in a second one of said plurality of queues, wherein said second one of said plurality of queues being associated with said second one of said plurality of priorities.

21. The system according to claim 17, further comprising:
said plurality of HTTP requests being received by said application; and
a priority associated with a type of each one of said plurality of HTTP requests being determined.

22. The system according to claim 17, further comprising:
one of said plurality of HTTP requests being received by said application;
said CPU executing code for determining whether there is a backlog of pending requests waiting to be processed by said application;
in response to a determination that there is no backlog, said one of said plurality of HTTP requests being immediately processed;
in response to a determination that there is a backlog, a type of said one of said plurality of requests being determined;
a priority associated with said type being identified;
one of a plurality of queues that is associated with said priority being identified; and
said one of said plurality of requests being stored in said identified one of said plurality of queues.

23. The system according to claim 17, further comprising:
a plurality of different queues;
each one of said plurality of different queues being associated with a different one of a plurality of priorities; and
requests stored in one of said plurality of queues that is associated with a first priority being processed before processing requests stored in one of said plurality of queues that is associated with a second priority.

24. The system according to claim 23, further comprising:
ones of said plurality of requests having a type associated with a high priority being stored in one of said plurality of queues that is associated with said high priority;
ones of said plurality of requests having a type associated with a low priority being stored in one of said plurality of queues that is associated with said low priority; and
said ones of said plurality of requests stored in said one of said plurality of queues that is associated with said high priority being processed before said ones of said plurality of requests stored in said one of said plurality of queues that is associated with a low priority are processed.
